(19) United States
(12) Patent Application Publication
(10) Pub. No.: US 2011/0085739 A1
(43) Pub. Date: Apr. 14, 2011

(54) SYSTEM AND METHOD FOR SIMILARITY SEARCH OF IMAGES

(76) Inventors: Dong-Qing Zhang, Plainsbero, NJ (US); Rajan Joshi, San Diego, CA (US); Ju Guo, Arcadia, CA (US); Ana B. Benitez, New York, NY (US); Ying Luo, Stevenson, CA (US)

(21) Appl. No.: 12/996,424

(22) PCT Filed: Jun. 6, 2008
(86) PCT No.: PCT/US08/07208

§ 371 Date: Dec. 6, 2010

(51) Int. Cl. G06K 9/68; G06K 9/62; G06K 9/46

(52) U.S. Cl. 382/218; 382/224; 382/190; 382/225

(57) ABSTRACT

A system and method for an efficient semantic similarity search of images with a classification structure are provided. The system and method provide for building a semantic classification-search tree for the plurality of images, the classification tree including at least two categories of images, each category of images representing a subset of the plurality of images, receiving a query image, classifying the query image to select one of the at least two categories of images, and restricting the search for the image of interest using the query image to the selected one of the at least two categories of images.

### TECHNICAL FIELD OF THE INVENTION

The present disclosure generally relates to computer graphics processing and display systems, and more particularly, to a system and method for similarity search of images.

### BACKGROUND OF THE INVENTION

Detection and retrieval of an image similar to a query image is very useful in a variety of real-world applications. The technology described in this disclosure deals with the problem of querying an image database to find the images that are similar to a query image, preferable at the semantic level (i.e. images that contain the same objects and background but possibly with some variations). This problem arises in a variety of applications, for example, location-aware service for mobile devices, where a user takes a picture of a landmark and then the mobile device can tell the user the location and the description of the landmark. In another application, the user can take a picture of one or more products in a store, and then the mobile device can return a webpage with the same products provided by different retailers with the corresponding prices. In the context of copyright infringement detection, one can identify likely copyright violation by searching over the Internet for the unauthorized use of images. In multimedia content management, detecting image duplicates and near-duplicates can help link the stories in multi-source videos, articles in press and web pages.

Although the technology described in this disclosure can be applied to general image or video retrieval or search, the present disclosure focuses on image and video search at the semantic level, rather than visual search based on low-level features such as color, texture, etc. Image or video search based on low-level features has been well studied and highly efficient retrieval algorithms are available for large-scale databases. Image or video search at the semantic level is much more difficult than low-level feature search, because it involves the comparison of the objects contained in the images or videos. For many real-world applications, such as the aforementioned applications discussed above, the low-level feature based search in general is not sufficient because images containing different objects could have similar color or texture.

Image or video search at the semantic level requires comparison of objects in the images. Similar images defined in this sense should contain the same objects and background, but could have some variations such as object motion, lighting change, etc. The problem is very challenging because it's very difficult for computers, computing devices, and the like to understand images or represent images at the semantic level. There has been some earlier work performed on searching images and videos at the semantic level. For example, a parts-based similarity measure for accurate near-duplicate detection and search using machine learning methods is described by D. Q. Zhang and S. F. Chang, in “Detecting Image Near-Duplicate by Stochastic Attributed Relational Graph Matching with Learning”, In ACM Multimedia, New York City, USA, October 2004. The similarity measure described by Zhang et al. actually compares the objects within images obtaining very high accurate results. However, this method is very slow compared to traditional retrieval methods using low-level features (e.g. by color histogram) and cannot be applied to real-world applications.

Therefore, a need exists for techniques for efficient searching of images at the semantic level. Furthermore, a need exists for speeding up an image search even when an image similarity measure is available.

### SUMMARY

A system and method for an efficient semantic similarity search of images with a classification structure are provided. The system and method enables querying of an image database to find the images that are similar to a query image at the semantic level, i.e., images that contain the same objects and background as the query image but possibly with some variations. The techniques of the present disclosure restrict the semantic similarity search of images within certain classes or categories so that the similarity computation is greatly reduced. Initially, a classification-search tree for all of the images in a database is built up. Then, for each incoming query image, the query image is classified to one or more categories (typically semantic categories, such as people, indoor, outdoor etc.), which represent a subset of the entire image space, i.e., the database of images. The image similarity computation is then restricted within that subset.

According to one aspect of the present disclosure, a method for searching a plurality of images for an image of interest is provided. The method includes building a classification structure for the plurality of images, the classification structure including at least two categories of images, each category of images representing a subset of the plurality of images, receiving a query image, classifying the query image to select one of the at least two categories of images, and restricting the search for the image of interest image to the selected one of the at least two categories of images.

According to another aspect, a system for searching a plurality of images for an image of interest includes a database including a plurality of images structured into at least two semantic categories of images, each semantic category of images representing a subset of the plurality of images, means for acquiring at least one query image, an image classifier module for classifying the query image to select one of the at least two semantic categories of images, and an image searcher module for searching for the image of interest using the query image, wherein the search is restricted to the selected one of the at least two semantic categories of images.

According to a further aspect, a program storage device readable by a machine, tangibly embodying a program of instructions executable by the machine to perform method steps for searching a plurality of images for an image of interest is provided. The method includes building a classification structure for the plurality of images, the classification structure including at least two categories of images, each category of images representing a subset of the plurality of images, receiving a query image, classifying the query image to select one of the at least two categories of images, and restricting the search for the image of interest to the selected one of the at least two categories of images.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is an exemplary illustration of a system for similarity searching of images according to an aspect of the present disclosure;

FIG. 2 is a flow diagram of an exemplary method for similarity searching of images according to an aspect of the present disclosure;

FIG. 3 illustrates a classification-search tree in accordance with the present disclosure;

FIG. 4 illustrates a simple search performed in a classification-search tree in accordance with the present disclosure;

FIG. 5 illustrates a redundant search performed in a classification-search tree in accordance with the present disclosure;

FIG. 6 illustrates a method for building or generating a classification-search tree according to an aspect of the present disclosure;

FIG. 7 illustrates a feature vector for an image with tagged keywords; and

FIG. 8 illustrates a method for adding a new image into a classification-search database according to an aspect of the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Detection and retrieval of an image similar to a query image is very useful in a variety of real-world applications. The problem is to efficiently find images that are similar (i.e., they are shot from the same scene and have the same objects) to the query image at the semantic level. Some previous work has proposed highly-accurate algorithms for semantic image search with low speed. The efficiency problem is particularly important if the image database is large. Usually, the time to search an image database scales up linearly to the size of the database. The system and method of the present disclosure speeds up the search by taking advantage of the image database structure as well as the semantic meaning of the images.

A system and method for the efficient search of images or videos with a hierarchical process are provided. Assuming high-quality image or video similarity algorithms or functions are already available, the speed of the algorithms is much slower than traditional feature-based similarity computation algorithms. Therefore, the system and method of the present disclosure provides a speedup process to accelerate the semantic search in the image or video database. For the sake of abbreviation, the present disclosure will focus on image search, although the same techniques can be applied to videos, i.e., a sequence of images. The system and method speeds up the search algorithm by taking advantage of the structure of the image content space. The techniques of the present disclosure restrict the visual similarity search of images within certain classes or, categories so that the similarity computation is greatly reduced. Initially, a classification structure, such as but not limited to a classification tree, for all of the images in the database is built up. Then, for each incoming query image, the image is classified to one or more categories (typically semantic categories, such as people, indoor, outdoor etc.), which represent a subset of the entire image space. The image similarity computation is then restricted within that subset.

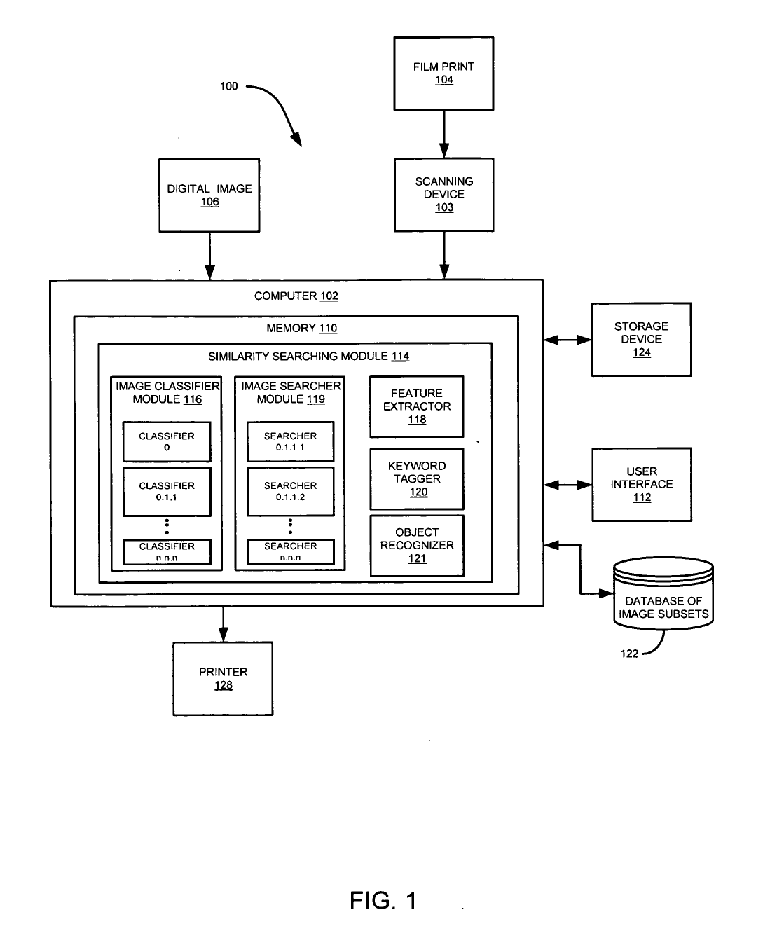

Referring now to the Figures, exemplary system components 100 according to an embodiment of the present disclosure are shown in FIG. 1. A scanning device 103 may be provided for scanning film prints 104, e.g., camera-original film negatives, into a digital format, e.g. Cineon-format or Society of Motion Picture and Television Engineers (“SMPTE”) Digital Picture Exchange (“DPX”) files. The scanning device 103 may comprise, e.g., a telecine or any device that will generate a video output from film such as, e.g., an Arri LocPro™ with video output. Alternatively, files from the post production process or digital cinema 106 (e.g., files already in computer-readable form) can be used directly. Potential sources of computer-readable files are AVID™ editors, DPX files, D5 tapes etc.

Digital images or scanned film prints are input to a post-processing device 102, e.g., a computer. The computer is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as post-processing device 102. In addition, various other peripheral devices may be connected to the computer platform by various interfaces and bus structures, such a parallel port, serial port or universal serial bus (USB). Other peripheral devices may include additional storage devices 124 and a printer 128.

Alternatively, files/film prints already in computer-readable form 106 (e.g., digital cinema, which for example, may be stored on external hard drive 124) may be directly input into the computer 102. Note that the term “film” used herein may refer to either film prints or digital cinema.

A software program includes a similarity searching module 114 stored in the memory 110 for efficient searching of an image of interest based on a query image. The similarity searching module 114 further includes an image classifier module 116 configured for creating a plurality of classifiers and sub-classifiers for classifying the query image into at least one category. A feature extractor 118 is provided to extract features from the images. Feature extractors are known in the art and extract features including but not limited to texture, line direction, edges, etc. In one embodiment, the classifiers include a pattern recognition function which classifies a query image based on extracted features.

The similarity searching module 114 further includes an image searcher module 119 including a plurality of image searchers each configured for searching in an image subset of the database of images 122. Each image searcher will employ a similarity measure to determine an image of interest from a query image.

A keyword tagger 120 is provided for tagging each image of the database with a feature. In one embodiment, the keyword tagger 120 will includes a dictionary of N keywords and the keyword tagger 120 can be used to generate a feature vector from the keywords. The tagged features can be used to store the images into a plurality of subsets. Furthermore, in one embodiment, the image classifier module 116 will use the keywords to create the classifiers.

Furthermore, the similarity searching module 114 includes an object recognizer 121 for recognizing objects in the images in the database. By using the recognized objects, the image classifier module 116 can learn from the objects and build classifiers based on the objects.

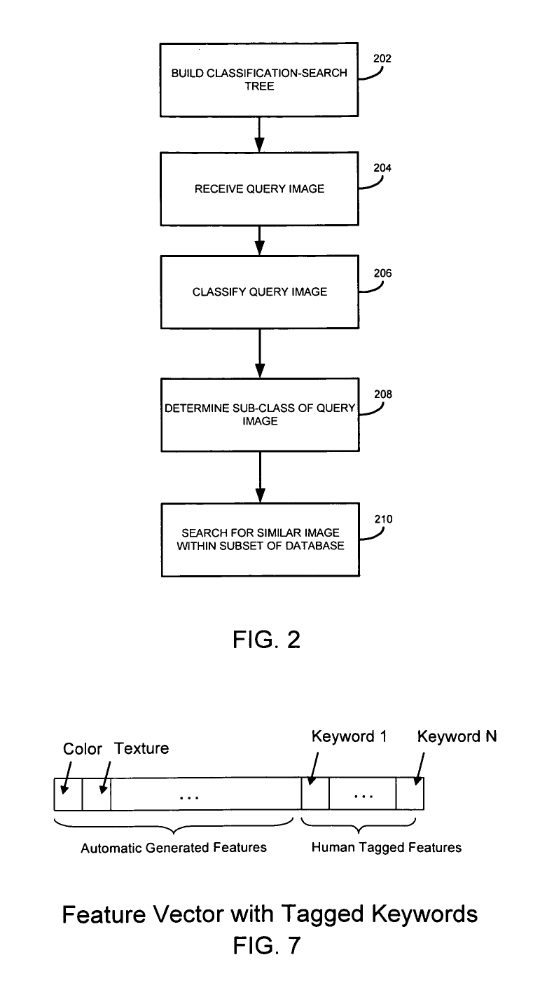

FIG. 2 is a flow diagram of an exemplary method for similarity searching of images with a classification data structure such as, but not limited to, a classification-search tree according to an aspect of the present disclosure. Initially, in step 202, a classification-search tree is built, as will be described in more detail below. Then, the post-processing device 102 acquires at least one two-dimensional (2D) image, e.g., a query image, in step 204. The post-processing device 102 may acquire the query image by obtaining a digital image file in a computer-readable format via for example consumer grade camera. Although the techniques of present disclosure are described in terms of an image, a sequence of images, e.g., video, may also utilize the techniques of the present disclosure. The digital video file may be acquired by capturing a temporal sequence of moving images with a digital camera. Alternatively, the video sequence may be captured by a conventional film-type camera. In this scenario, the film is scanned via scanning device 103.

In step 206, the query image is classified by the classifiers and subsequently classified by the sub-classifiers, in step 208, until the lower most level of the tree or branch of the tree is reached. In step 210, a similarity search is performed by a searcher within an image subset of database 122 rather than for the entire image space or database. The details of building or generating the classification-search tree and performing a search within the tree will now be described.

The system and method of the present disclosure employs a tree-based search to restrict image comparison within a small subset of the database. The tree-based search is based on image classification as will be described below. The classification tree is either built automatically or by manually tagging the images with keywords.

The system and method of the present disclosure speeds up the searching process by restricting the search for an image of interest along a branch of a classification-search tree. In performing the search, it is assumed a high-accuracy similarity measure S(I_{q},I_{d}) is available, where I_{q} is the query image, and I_{d} are the images in the database. A similarity measure is a number indicating how similar two images are, for example, 1.0 means the two images are the same, 0.0 means the two images are completely different. Distance usually can be thought of as the inverse of the similarity. One example of similarity is the inverse distance of the color histograms of two images. Similarity measures are known in the art and it is also likely that such image similarity measure is “learnable” for a certain image category such that the similarity search is optimized within that category. It's also likely that such similarity measure is designed manually for certain image categories. For either case, a similarity measure adaptive to the image category C is denoted as S_{C}(I_{q},I_{d}).

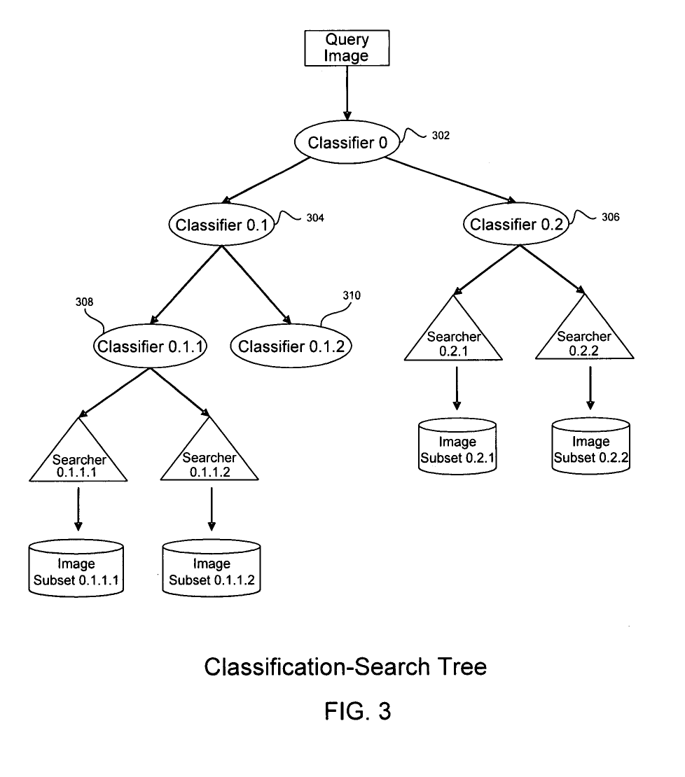

A classification-search tree is a tree where each intermediate node in the tree uses a classifier to detect or classify one or more categories in images. Each branch in the tree represents a category. Only the branches of the detected categories would then be traversed in the tree. As shown in FIG. 3, each leaf node 302, 304, 306, 308, 310 in the tree represents the images corresponding to a specific category. The classification-search tree can have multiple layers or levels. For example, the tree in FIG. 3 has three levels. Furthermore, as can be seen from FIG. 3, the classification-search tree includes classifiers and searchers.

Classifiers are used to classify the query image into categories. In one embodiment, the classifiers are pattern recognition or machine learning algorithms or functions based on automatically extracted features, e.g. color and texture, among others. The general procedure of classification follows: a feature vector is first extracted from the image, and then a pattern recognition algorithm or function takes the feature vector and outputs one or more class labels with optional confidence scores (e.g., class IDs and scores), which represent one or more certain image categories. In general, a pattern recognition algorithm is a function which takes the feature vector as an input and outputs an integer number which indicates the ID of the class; alternatively, the pattern recognition function compares the extracted vector to stored vectors. Other pattern recognition algorithms or functions are known in the art. Classifiers can be also binary. In this case, the classifier will output a yes or no label, indicating whether or not the image belongs to certain category, respectively. Classifiers can be either manually designed or automatically built from example data.

A searcher is a program used to compute the similarity of images and find the image of interest with a maximum similarity to the query image.

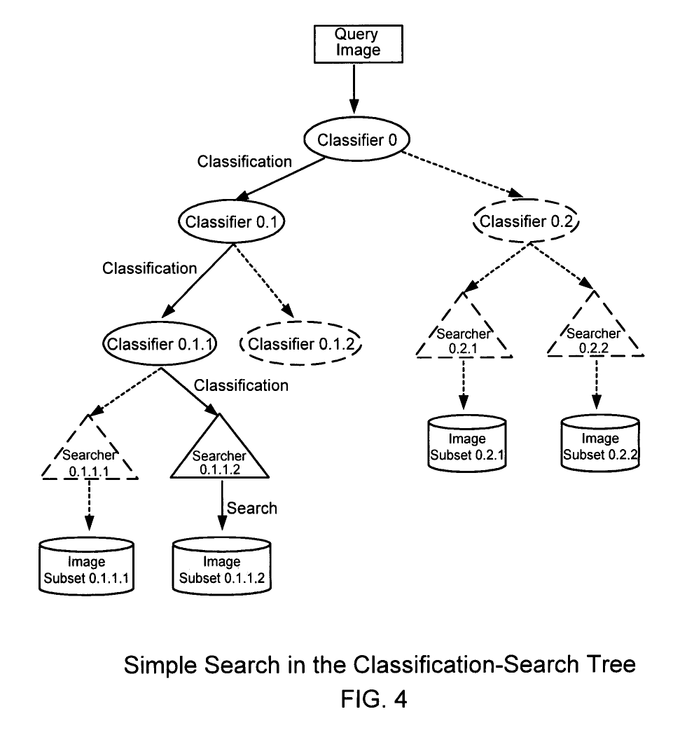

In the case of simple classification-search, a query image is classified to one and only one category at each level; assuming the leaf category is category C. After the classification is done, namely, the query image reaches the bottom (leaf layer) of the classification-search tree, the similarity measure S_{C}(I_{q},I_{d}) calculation is carried out to search the images within the database subset corresponding to the image category C, as shown in FIG. 4. In FIG. 4, and in the remaining figures, the branch or leaf nodes traversed during a search is indicated in a solid line while classifiers and searchers not traversed are shown in dashed lines. For example, in FIG. 4, a query image is received and submitted to classifier 0. At classifier 0, it is determined that the image is to be further classified at classifier 0.1, e.g., a sub-classifier. From classifier 0.1, the query image is submitted to classifier 0.1.1 where is it determined to use searcher 0.1.1.2 to search for a similar image to the query image in image subset 0.1.1.2. It is to be appreciated that by restricting the search for the image of interest to the image subset 0.1.1.2, the search will be performed more efficiently and quickly.

The output of the classifier in this case can be either binary or n-ary. If it's a binary classifier, then the output of the classifier indicates whether or not the query image belongs to a category. Likewise, if it's an n-ary classifier, the output of the classifier could be an integer value that indicates which category the query image belongs to. If all of the classifiers in the classification-search tree are binary, the tree would is a binary tree; otherwise, it would be a non-binary classification-search tree.

One problem of simple classification-search is that if there is classification error, then the query image may go to a complete wrong category, resulting in wrong search results. The problem can be solved by redundant search, where multiple categories are searched rather one category.

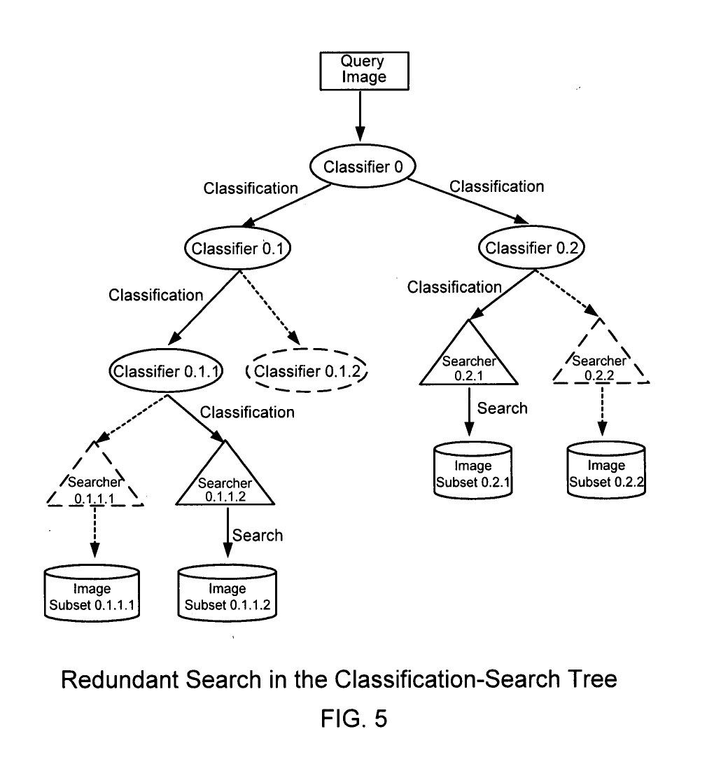

Referring to FIG. 5, in the case of redundant classification-search, a query image is classified to more than one leaf category, for example, classifier 0.1 and classifier 0.2. After classification is done, namely, the query image reaches several categories in the bottom (leaf layer) of the classification-search tree, e.g., classifier 0.1.1 and classifier 0.2. Then, the similarity measure S_{C}(I_{q},I_{d}) calculation is carried out to search the images within the database subsets corresponding to the selected image categories C; in the example of FIG. 5, searcher 0.1.1.2 will search image subset 0.1.1.2 and searcher 0.2.1 will search image subset 0.2.1.

To realize the redundant classification-search, the output of the classifiers have to be a list of class labels and float values representing the confidence that the corresponding category is present in the query image. Then a thresholding procedure can be used to get a list of categories whose classifier outputs are larger than the threshold. The query image is decided to belong to the resulting list of categories. After the bottom level of the tree is reached, a similarity score for each image from the list of categories will be determined and then the image with the maximum similarity score is selected as the image of interest.

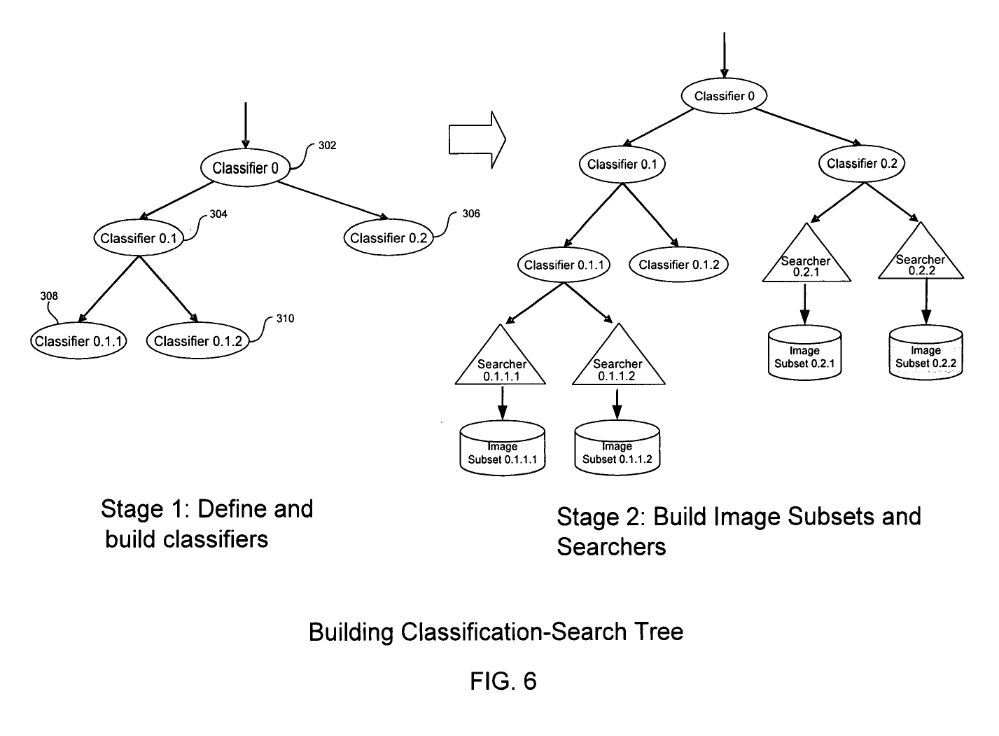

To enable efficient searching for images, the classification-search tree is to be built to structure the image space so all the images do not have to be searched every time. Referring to FIG. 6, building or generating the classification-search tree includes two stages. In the first stage, all the branches of the tree are built, which includes building all the classifiers and organizing the classifiers into a tree if the classification-search tree has multiple layers. In the second stage, the images in the database are classified into categories to form subsets of images in the database. Furthermore, the searchers are defined for searching within each subset of images.

To build the classification-search tree, the classifiers at intermediate nodes in the tree have to be built first. Each classifier will correspond to one semantic class (e.g. outdoor scene, trees, human faces etc.). The semantic classes can be determined manually by humans or automatically using clustering algorithms or functions. The relationships between the classifiers (i.e. the tree structure) can be defined by a human designer.

Once the semantic classes are defined, semantic classifiers have to be built for the intermediate nodes, e.g., sub-classifiers 304, 306, 308, 310. Each classifier, or sub-classifier, can be built one by one with different methodologies. In one embodiment, a “generic” classifier is provided, and then the “generic” classifier learns from the example images of each image category. Such methodology enables the system and method of the present disclosure to build a large number of semantic classifiers without specifically designing each classifier. This type of classifier is called a learning-based scene or object recognizer. An exemplary learning-based scene or object recognizer was disclosed by R. Fergus, P. Perona, and A. Zisserman, in “Object Class Recognition by Unsupervised Scale-Invariant Learning”, Proc. of the IEEE Conf on Computer Vision and Pattern Recognition 2003. In the Fergus et al. paper, a method to learn and recognize object class models from unlabeled and unsegmented cluttered scenes in a scale invariant manner was described. In the method, objects are modeled as flexible constellations of parts. A probabilistic representation is used for all aspects of the object: shape, appearance, occlusion and relative scale. An entropy-based feature detector is used to select regions and their scale within the image. In learning, the parameters of the scale-invariant object model are estimated. This is done using expectation-maximization in a maximum-likelihood setting. In recognition, this model is used in a Bayesian manner to classify images.

Another way of defining and building classifiers is to use “keyword tagging” by the image users. For “keyword tagging”, the image users will manually assign keywords to the images, such as “trees”, “faces”, “blue sky” etc. These manually tagged keywords can be considered a type of features of the image, therefore can be used for the classification purpose. For example, a keyword spotting classifier can be build to classify the images into certain classes once the classifier spots certain keywords. More sophisticatedly, the tagged keywords can be treated as a type of feature and converted into feature vectors. This is realized by a technique used in Image Retrieval called “term vector”. Basically, a dictionary with N keywords is built and, for each image tagged with keywords, a keyword feature vector with N dimensions will be assigned to the image. If the image is tagged with ith keyword in the dictionary, then 1 is assigned to the ith element of the term vector, otherwise 0 is assigned. As a result, a term vector for each image is provided to represent the semantic meaning of the image. Such a term vector can be concatenated with the regular feature vectors described above to form a new feature vector for image classification, as illustrated in FIG. 7.

For each image subset, an image searcher is either manually designed or learned. The image searcher is used to perform similarity search within subsets of the database.

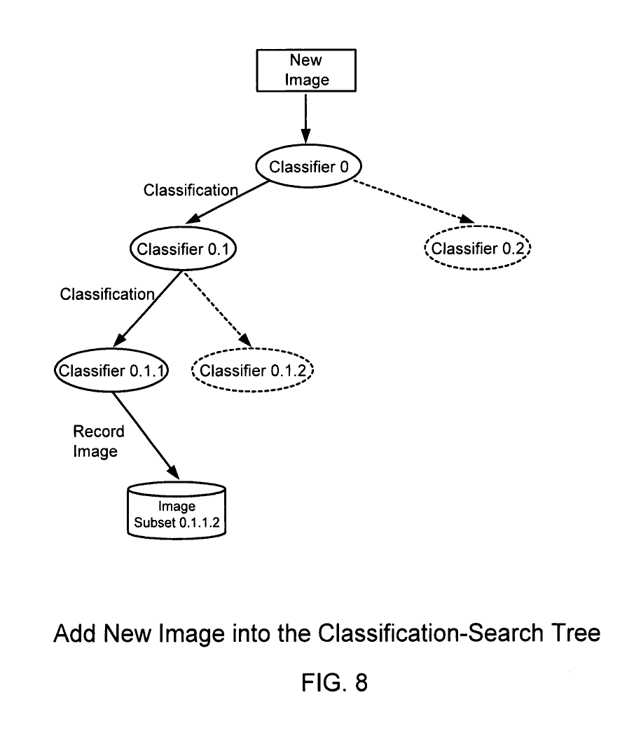

After the classifiers are defined and built, images in the database are classified into subsets. The way of building the image subsets is very similar to the classification-search process. When an image is put into the database, it is automatically classified in the classification tree, until it reaches the bottom level of the classification tree, where the image is put into the image pool corresponding to one of the bottom level classifier, as shown in FIG. 8.

A potential problem is that images may contain more than two semantic objects, for example, an image containing people and trees. If in the classification tree, there are two semantic classes, e.g., “people” and “trees”, then there would be ambiguity of classifying that image into one class. This problem could be solved by redundant classification described above. Namely, the incoming image can be classified into two subsets.

Although embodiments which incorporate the teachings of the present disclosure have been shown and described in detail herein, those skilled in the art can readily devise many other varied embodiments that still incorporate these teachings. Having described preferred embodiments for a system and method for efficient and semantic similarity search of images with a classification-search tree (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for searching a plurality of images for an image of interest, the method comprising the steps of:
building a classification structure for the plurality of images, the classification structure including at least two categories of images, each category of images representing a subset of the plurality of images;
receiving a query image;
classifying the query image to select one of the at least two categories of images; and
restricting the search for the image of interest image to the selected one of the at least two categories of images.

2. The method of claim 1, wherein the classification structure is a semantic classification search tree.

3. The method of claim 1, wherein the step of classifying the query image includes:
extracting a feature from the query image; and
identifying one of the at least two categories based on the extracted feature.

4. The method of claim 1, wherein the step of classifying the query image is performed by a pattern recognition function.

5. The method of claim 1, wherein the step of building the classification structure includes determining a classifier for each category of images, wherein the classifier classifies an image to one of the at least two categories.

6. The method of claim 5, wherein the step of determining a classifier is performed by applying a clustering function to the plurality of images.

7. The method of claim 5, further comprising the step of determining at least one sub-classifier for each determined classifier.

8. The method of claim 5, further comprising the steps of:
classifying each of the plurality of images based on the determined classifier; and
storing each of the plurality of images into at least one subset of the plurality of images.

9. The method of claim 1, wherein the step of building the classification structure includes:
tagging each image of the plurality of images with a feature keyword; and
storing each of the plurality of images into at least one subset of the plurality of images based on the feature keyword.

10. The method of claim 9, further comprising the step of determining a classifier for each category of images based on the feature keyword.

11. The method of claim 1, wherein the step of building the classification structure further includes the steps of:
recognizing an object from each of the plurality of images of the at least two categories of images; and
determining a classifier for each category of images based on the recognized object of each image, wherein the classifier classifies an image to one of the at least two categories.

12. The method of claim 1, wherein the search for the image of interest is performed by a similarity measure.

13. The method of claim 1, further comprising the steps of:
classifying the query image in at least two of the at least two categories of images;
searching for the image of interest using the query image in the at least two categories of images;
determining a similarity score for each image found in each of the at least two categories; and
selecting the image with the highest similarity score as the image of interest.

14. A system for searching a plurality of images for an image of interest comprising:
a database including a plurality of images structured into at least two semantic categories of images, each semantic category of images representing a subset of the plurality of images;
means for acquiring at least one query image;
an image classifier module for classifying the query image to select one of the at least two semantic categories of images; and
an image searcher module for searching for the image of interest using the query image, wherein the search is restricted to the selected one of the at least two semantic categories of images.

15. The system of claim 14, further comprising a feature extractor for extracting a feature from the query image, wherein the image classification module identifies one of the at least two categories based on the extracted feature.

16. The system of claim 14, wherein the image classifier module includes a pattern recognition function.

17. The system of claim 14, further comprising means for building a semantic classification-search tree including a classifier for each category of images, wherein the classifier classifies an image to one of the at least two categories.

18. The system of claim 17, wherein the image classifier module determines the classifier by applying a clustering function to the plurality of images.

19. The system of claim 17, wherein the image classifier module determines a sub-classifier for each determined classifier.

20. The system of claim 17, wherein the image classifier module classifies each of the plurality of images based on the determined classifier and stores each of the plurality of images into a subset of the plurality of images in the database.

21. The system of claim 17, further comprising a keyword tagger for tagging each image of the plurality of images with a feature keyword and storing each of the plurality of images into a subset of the plurality of images of the database based on the feature keyword.

22. The system of claim 21, wherein the image classifier module determines the classifier for each category of images based on the feature keyword.

23. The system of claim 17, further comprising an object recognizer for recognizing an object from each of the plurality of images of the at least two categories of images and the image classifier module determines the classifier for each category of images based on the recognized object of each image.

24. The system of claim 14, wherein the image searcher module includes a similarity measure.

25. The system of claim 14, wherein the image classifier module classifies the query image in at least two of the at least two categories of images and the image searcher module searches for the image of interest using the query image in the at least two categories of images, determines a similarity score for each image found in each of the at least two categories, and selects the image with the highest similarity score as the image of interest.

26. A program storage device readable by a machine, tangibly embodying a program of instructions executable by the machine to perform method steps for searching a plurality of images for an image of interest, the method comprising the steps of: [symbol]
